(19) United States
(12) Patent Application Publication
(10) Pub. No.: US 2023/0373340 A1
(43) Pub. Date: Nov. 23, 2023

(54) SERVER AND METHOD OF CONTROLLING THE SAME

(71) Applicants: Hyundai Motor Company, Seoul (KR); Kia Corporation, Seoul (KR)

(72) Inventor: Seungwoo HA, Seoul (KR)

(73) Assignees: Hyundai Motor Company, Seoul (KR); Kia Corporation, Seoul (KR)

(21) Appl. No.: 18/078,477

(22) Filed: Dec. 9, 2022

(30) Foreign Application Priority Data
May 18, 2022 (KR) 1020220060937

(51) Int. Cl. B60L 53/66; B60L 53/67; B60L 53/62; G06Q 10/02; G06Q 50/06

(52) U.S. Cl. CPC B60L 53/665; B60L 53/67; B60L 53/62; G06Q 10/02; G06Q 50/06

(57) ABSTRACT

A server includes a communicator configured to communicate with a plurality of vehicles and a plurality of chargers, and a controller configured to determine an expected returning time of each of first vehicles returning to an area where the plurality of chargers are provided among the plurality of vehicles and an expected profit according to charging and discharging of each of the first vehicles at an available charger and determine that a first vehicle including the highest expected profit for each charger among the plurality of first vehicles is a vehicle to be connected to each charger.

### CROSS-REFERENCE TO RELATED APPLICATION

The present application claims priority to Korean Patent Application No. 10-2022-0060937, filed on May 18, 2022, the entire contents of which is incorporated herein for all purposes by this reference.

### BACKGROUND OF THE PRESENT DISCLOSURE

### Field of the Present Disclosure

The present disclosure relates to a server for operating a vehicle to grid (V2G) system and a method of controlling the same.

### Description of Related Art

A vehicle to grid (V2G) system is a system using a technology which connects an electric vehicle (EV) to a building to use the electric vehicle as an energy storage device. In other words, the V2G system may maintain a state of charge (SOC) value of a battery of the electric vehicle using a target SoC, and when the SOC value of the battery of the electric vehicle is higher than the target SoC, the battery of the electric vehicle is discharged to charge a battery of the building to generate a profit.

As described above, the V2G system may repeatedly charge and discharge the battery of the electric vehicle to generate the profit, and electric vehicles participating in the V2G system are not charged in 100% SoC, so that a situation in which the SoC is often insufficient compared to general electric vehicles may occur.

There is no problem when there are enough chargers for charging the electric vehicles participating in the V2G system, but when the chargers are insufficient, there is a demand for a system which may efficiently charge and manage the electric vehicles participating in the V2G system.

The information included in this Background of the present disclosure is only for enhancement of understanding of the general background of the present disclosure and may not be taken as an acknowledgement or any form of suggestion that this information forms the prior art already known to a person skilled in the art.

### BRIEF SUMMARY

Therefore, it is an aspect of the present disclosure to provide a server configured to identify returning vehicles which return to a position where chargers are provided among vehicles participating in a vehicle to grid (V2G) based on position information, determine a charge order among the returning vehicles, and inform the vehicles of the charge order, and a method of control the same.

In accordance with one aspect of the present disclosure, a server includes a communicator configured to communicate with a plurality of vehicles and a plurality of chargers and a controller configured to determine an expected returning time of each of first vehicles returning to an area where the plurality of chargers are provided among the plurality of vehicles and an expected profit according to charging and discharging of each of the first vehicles at an available charger and determine that a first vehicle including the highest expected profit for each charger among the plurality of first vehicles is a vehicle to be connected to each charger.

The controller may be configured to determine that a vehicle in which a distance between the area where the plurality of chargers are provided and a current position is decreased among the plurality of vehicles is the first vehicle based on position information of each of the vehicles received through the communicator.

The controller may be configured to determine that a vehicle in which a moving average over time of the distance between the area where the plurality of chargers are provided and the current position is decreased among the plurality of vehicles is the first vehicle based on the position information of each of the vehicles.

The controller may predict a state of charge (SoC) at the expected returning time of each of the first vehicles based on SoC information received from the plurality of first vehicles through the communicator and the expected returning time of each of the first vehicles.

The controller may be configured to determine the expected profit according to the charging and discharging of each of the first vehicles at the available charger based on an output of an optimization algorithm for electricity rate information over time, and the expected returning time, an expected SoC at the expected returning time, a next reservation time, and a required SoC at the next reservation time of each of the first vehicles.

The controller may be configured to determine that a profit in the case including the highest sum of an income due to discharging and an expenditure due to charging as an SoC changes from the expected SoC to the required SoC from the expected returning time to the next reservation time is the expected profit based on the electricity rate information over time.

The controller may be configured to determine one or more first chargers to which the vehicle is expected not to be connected at the expected returning times of the plurality of first vehicles among the plurality of chargers based on a next reservation time of each of one or more second vehicles connected to the charger among the plurality of vehicles and the expected returning time of each of the first vehicles.

The controller may be configured to determine that the first vehicle including the highest expected profit in each of the one or more first chargers is a vehicle to be connected to each of the one or more first chargers.

The controller may be configured to control the communicator to transmit a message, which informs a connection to the charger, to at least one of the vehicles to be connected and a user terminal of a driver of the vehicle to be connected.

The controller may be configured to determine that a vehicle which is not the vehicle to be connected among the plurality of first vehicles is a vehicle to be parked and control the communicator to transmit a message, which informs a connection limit to the charger, to at least one of the vehicles to be parked and a user terminal of a driver of the vehicle to be parked.

A method of controlling a server according to an exemplary embodiment including a communicator configured to communicate with a plurality of vehicles and a plurality of chargers includes determining an expected returning time of each of first vehicles returning to an area where the plurality of chargers are provided among the plurality of vehicles and an expected profit according to charging and discharging of each of the first vehicles at an available charger and determining that a first vehicle including the highest expected profit for each charger among the plurality of first vehicles is a vehicle to be connected to each charger.

The method may further include determining that a vehicle in which a distance between the area where the plurality of chargers are provided and a current position is decreased among the plurality of vehicles is the first vehicle based on position information of each of the vehicles received through the communicator.

The determining of the plurality of first vehicles may include determining that a vehicle in which a moving average over time of the distance between the area where the plurality of chargers are provided and the current position is decreased among the plurality of vehicles is the first vehicle based on the position information of each of the vehicles.

The method may further include predicting a state of charge (SoC) at the expected returning time of each of the first vehicles based on SoC information received from the plurality of first vehicles through the communicator and the expected returning time of each of the first vehicles.

The determining of the expected profit may include determining an expected profit according to the charging and discharging of each of the first vehicles at the available charger based on an output of an optimization algorithm for electricity rate information over time, and the expected returning time, an expected SoC at the expected returning time, a next reservation time, and a required SoC at the next reservation time of each of the first vehicles.

The determining of the expected profit may include determining a profit in the case including the highest sum of an income due to discharging and an expenditure due to charging as an SoC changes from the expected SoC to the required SoC from the expected returning time to the next reservation time as the expected profit based on the electricity rate information over time.

The method may further include determining one or more first chargers to which the vehicle is expected not to be connected at the expected returning times of the plurality of first vehicles among the plurality of chargers based on a next reservation time of each of one or more second vehicles connected to the charger among the plurality of vehicles and the expected returning time of each of the first vehicles.

The determining of the vehicle to be connected may include determining that a first vehicle including the highest expected profit in each of the one or more first chargers is the vehicle to be connected to each of the one or more first chargers.

The method may further include controlling the communicator to transmit a message, which informs a connection to the charger, to at least one of the vehicles to be connected and a user terminal of a driver of the vehicle to be connected.

The method may further include determining that a vehicle which is not the vehicle to be connected among the plurality of first vehicles is a vehicle to be parked and controlling the communicator to transmit a message, which informs a connection limit to the charger, to at least one of the vehicles to be parked and a user terminal of a driver of the vehicle to be parked.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1 shows a vehicle to grid (V2G) system according to an exemplary embodiment of the present disclosure;

FIG. 2 is a control block diagram of a server according to an exemplary embodiment of the present disclosure;

FIG. 3 schematically shows a case in which the server according to an exemplary embodiment controls the V2G system;

FIG. 4 is a view for describing a case in which the server according to an exemplary embodiment identifies a vehicle returning to an area where chargers are provided;

FIG. 5 is a view for describing a case in which the server according to an exemplary embodiment determines a vehicle to be connected to a charger among returning vehicles;

FIG. 6 is a view for describing that the server according to an exemplary embodiment determines an expected profit;

FIG. 7 is a view for describing a case in which the server according to an exemplary embodiment informs a connection to the charger or general parking to a driver;

FIG. 8 is a flowchart of a case of determining a vehicle to be connected to the charger among the returning vehicles to maximize an operating profit of the V2G system in a method of controlling the server according to an exemplary embodiment of the present disclosure; and

FIG. 9 is a flowchart of a case of determining a returning vehicle among a plurality of vehicles included in the V2G system in the method of controlling the server according to an exemplary embodiment of the present disclosure.

It may be understood that the appended drawings are not necessarily to scale, presenting a somewhat simplified representation of various features illustrative of the basic principles of the present disclosure. The specific design features of the present disclosure as disclosed herein, including, for example, specific dimensions, orientations, locations, and shapes will be determined in part by the particularly intended application and use environment.

In the figures, reference numbers refer to the same or equivalent parts of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

The same reference numerals indicate the same components throughout the specification. The specification does not describe all elements of the embodiments, and general contents in the art to which the present disclosure pertains or contents overlapping between the exemplary embodiments will be omitted.

Throughout the specification, when a certain portion is referred to as being “connected” to another portion, this includes not only a case in which the certain portion is directly connected to another portion but also a case in which the certain portion is indirectly connected thereto, and the indirect connection includes connection through a wireless communication network.

In addition, when a certain portion is referred to as “including” a certain component, this means that the certain portion may further include other components rather than precluding other components unless otherwise stated.

The singular expression includes the plural expression unless the context clearly states otherwise.

In addition, terms such as “unit,” “group,” “block,” “member,” and “—module” may each mean a unit for processing at least one function or operation. For example, the terms may mean at least one process processed by at least one hardware such as a field-programmable gate array (FPGA)/an application specific integrated circuit (ASIC), at least one software stored in a memory, or a processor.

The signs attached to each operation are used to identify each operation, and these signs do not indicate the order among the operations, and each operation is performed differently from the stated order unless the context clearly indicates a specific order.

Hereinafter, embodiments of a server and a method of controlling the same according to one aspect will be described in detail with reference to the accompanying drawings.

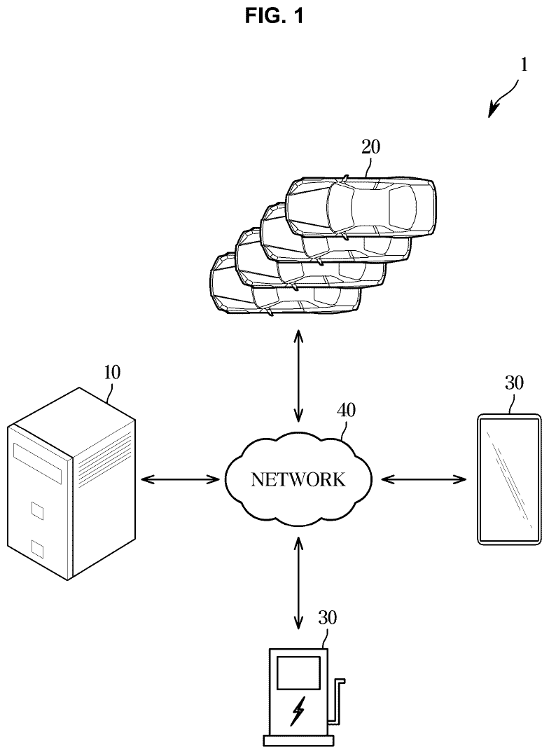

FIG. 1 shows a vehicle to grid (V2G) system according to an exemplary embodiment of the present disclosure.

Referring to FIG. 1, a V2G system 1 according to various exemplary embodiments of the present disclosure may include a server 10 for operating the V2G system 1, a plurality of vehicles 20 participating in the V2G system 1, at least one charger 30 for charging or discharging a battery of the vehicle 20, and a user terminal 40 of a driver of the vehicle 20.

The V2G system 1 is a system using a technology which connects an electric vehicle and a building to use the vehicle as an energy storage device and may discharge power of the electric vehicle to use the discharged power as power of the building when power charged in the electric vehicle is sufficient to generate a profit.

To the present end, the V2G system 1 includes the plurality of vehicles 20 and the plurality of chargers 30 which may charge the vehicle 20 or transmit the power discharged from the vehicle 20 to the building.

The server 10 according to various exemplary embodiments of the present disclosure may receive vehicle information including state of charge (SoC) information, reservation information, and position information from the vehicle 20 included in the V2G system 1 so that the V2G system 1 may be operated and schedule the charging and discharging of each vehicle 20 based on the vehicle information.

For example, the server 10 may correspond to a management server of a fleet company such as a rental vehicle company or a shared vehicle platform company, identify a returning vehicle returning to a position where the charger 30 is provided based on position information of each vehicle 20, and determine a charge order among the returning vehicles which may maximize an operating profit of the V2G system based on electricity rate information over time and an expected returning time, a next reservation time, and an SOC value of each returning vehicle.

The vehicle 20 according to various exemplary embodiments of the present disclosure may correspond to an electric vehicle including a motor and a battery for supplying power to the motor. However, according to the exemplary embodiment of the present disclosure, the vehicle 20 may also be a hybrid electric vehicle further including an engine.

The charger 30 according to various exemplary embodiments of the present disclosure may charge a battery of the vehicle 20 connected to the charger 30 or transmit power to a building participating in the V2G system 1 by discharging the power charged in the battery of the vehicle 20 connected to the charger 30 based on charge and discharge commands of the server 10.

The user terminal 40 according to various exemplary embodiments of the present disclosure may be a terminal of a driver of the vehicle 20. For example, the user terminal 40 may be a terminal of a user who utilizes a service of a fleet company.

The user may reserve the use of the vehicle 20 through the user terminal 40, and the server 10 may receive reservation information of the vehicle 20 from the user terminal 40. However, according to the exemplary embodiment of the present disclosure, the reservation information is not input only through the user terminal 40, and may also be directly input by a terminal of a service provider connected to the server 10.

Furthermore, the user terminal 40 may receive a message which informs a connection to the charger or general parking of the vehicle 20 from the server 10 and output the message to the user.

At the present time, the server 10, the vehicle 20, the charger 30, and the user terminal 40 may transmit or receive data to or from one another through a network 50.

The V2G system 1 has been briefly described above. Hereinafter, the server 10 of the V2G system 1 will be described in detail.

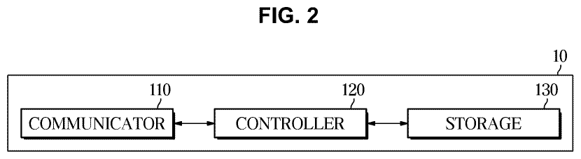

FIG. 2 is a control block diagram of the server 10 according to an exemplary embodiment of the present disclosure.

Referring to FIG. 2, the server 10 according to an exemplary embodiment includes a communicator 110 for communicating with an external device, a controller 120 for operating the V2G system 1, and a storage 130 for storing various types of information required for control.

The communicator 110 according to various exemplary embodiments of the present disclosure may transmit or receive data to or from the vehicle 20, the charger 30, and the user terminal 40 through the network 50. To the present end, the communicator 110 may be provided as at least one of a known type of wired communication module and a wireless communication module.

The controller 120 according to an exemplary embodiment can optimize an operating profit of the V2G system 1 by determining a plurality of first vehicles returning to an area where the charger 30 is provided among the plurality of vehicles 20 participating in the V2G system 1 and determining that a first vehicle including the highest expected profit for each charger 30 is a vehicle to be connected to the charger 30 based on the electricity rate information over time and the vehicle information of each of the first vehicles.

The controller 120 according to various exemplary embodiments of the present disclosure may determine the plurality of first vehicles returning to the area where the plurality of chargers 30 participating in the V2G system 1 are provided among the plurality of vehicles 20 and an expected returning time of each of the first vehicles based on the position information received from each of the vehicles 20 participating in the V2G system 1 through the communicator 110.

The controller 120 may determine that the vehicle 20 in which a distance between the area where the plurality of chargers 30 are provided and a current position is decreased among the plurality of vehicles 20 is the first vehicle based on the position information of each of the vehicles 20. In other words, the controller 120 may determine that the vehicle 20 approaching the area where the plurality of chargers 30 are provided is the first vehicle.

At the present time, according to the exemplary embodiment of the present disclosure, the controller 120 may determine that the vehicle 20 in which a moving average over time of the distance between the area where the plurality of chargers 30 are provided and the current position is decreased among the plurality of vehicles 20, is the first vehicle based on the position information of each of the vehicles 20.

The controller 120 according to various exemplary embodiments of the present disclosure may determine the expected returning time to the area (e.g., the parking space) where the plurality of chargers 30 are provided of each of the first vehicles using the position information of each of the first vehicles and a known navigation algorithm.

The controller 120 according to various exemplary embodiments of the present disclosure may predict an SoC at the expected returning time of each of the first vehicles based on SoC information received from each of the first vehicles through the communicator 110 and the expected returning time of each of the first vehicles. For example, the controller 120 may predict the SoC at the expected returning time by subtracting the amount of power to be consumed until the first vehicle returns from the current SoC based on a current SoC, a current time, the expected returning time, and an average amount of power consumed per hour. In the instant case, the average amount of power consumed per hour may vary in accordance with a driver's driving habit, whether an air conditioner operates according to weather, and the like.

The controller 120 according to various exemplary embodiments of the present disclosure may determine an expected profit according to the charging and discharging of each of the first vehicles at an available charger based on the electricity rate information over time and the expected returning time, the expected SoC at the expected returning time, a next reservation time, and a required SoC at the next reservation time of each of the first vehicles.

At the present time, the controller 120 may store the electricity rate information over time received from an external server through the communicator 110 in the storage 130.

Furthermore, the controller 120 may determine the next reservation time of each of the first vehicles based on at least one of reservation information received from the user terminal 40 and reservation information input through the terminal of the service provider.

According to the exemplary embodiment of the present disclosure, the required SoC at the next reservation time may be a value preset by the service provider and stored in the storage 130. However, according to the exemplary embodiment of the present disclosure, the controller 120 may also determine the required SoC based on the reservation information. For example, the controller 120 may adjust the required the SoC to be increased as a reservation interval becomes longer. Furthermore, the controller 120 may adjust the required SoC to be increased as an external temperature increases.

The controller 120 may determine the expected profit according to the charging and discharging of each of the first vehicles at the available charger 30 based on an output of an optimization algorithm (e.g., a dynamic programming (DP)) for the electricity rate information over time, the expected returning time, the expected SoC at the expected returning time, the next reservation time, and the required SoC at the next reservation time of each of the first vehicles.

At the present time, the controller 120 may determine a profit in the case including the highest sum of an income due to discharging and an expenditure due to charging as the SoC changes from the expected SoC to the required SoC from the expected returning time to the next reservation time as the expected profit based on the electricity rate information over time.

The controller 120 according to various exemplary embodiments of the present disclosure may determine one or more first chargers to which the vehicle 20 is expected not to be connected at the expected returning times of the plurality of first vehicles among the plurality of chargers 30 based on the next reservation time of each of one or more second vehicles connected to the charger 30 among the plurality of vehicles 20 and the expected returning time of each of the first vehicles.

At the present time, the controller 120 may determine the first vehicle including the highest expected profit in each of one or more first chargers as the vehicle to be connected to each of one or more first chargers.

The controller 120 according to various exemplary embodiments of the present disclosure may control the communicator 110 to transmit a message, which informs the connection to the charger 30, to at least one of the vehicles to be connected and a user terminal of a driver of the vehicle to be connected.

The controller 120 according to various exemplary embodiments of the present disclosure may determine that a vehicle which is not the vehicle to be connected among the plurality of first vehicles is a vehicle to be parked and control the communicator 110 to transmit a message, which informs the connection limit to the charger 30, to at least one of the vehicles to be parked and a user terminal of a driver of the vehicle to be parked.

The controller 120 may include at least one memory in which a program for performing the above-described operation and an operation to be described below is stored and at least one processor for executing the stored program. When a plurality of memories and processors are provided, the memories and processors may be integrated as one chip or may also be provided in physically separate positions.

The storage 130 according to various exemplary embodiments of the present disclosure may store various types of information required for control, and store, for example, driving tables of the vehicles 20 included in the V2G system 1, information (the total number of chargers and the like) on the charger included in the V2G system 1, operating information (target SoC and the like) of the V2G system 1, information on the electricity rate information over time, and the like. To the present end, the storage 130 may be provided as a known type of storage medium.

Each component of the server 10 has been described above in detail. Hereinafter, it will be described in detail that the server 10 determines the vehicle to be connected to the charger 30 among the plurality of returning vehicles to maximize the operating profit of the V2G system 1.

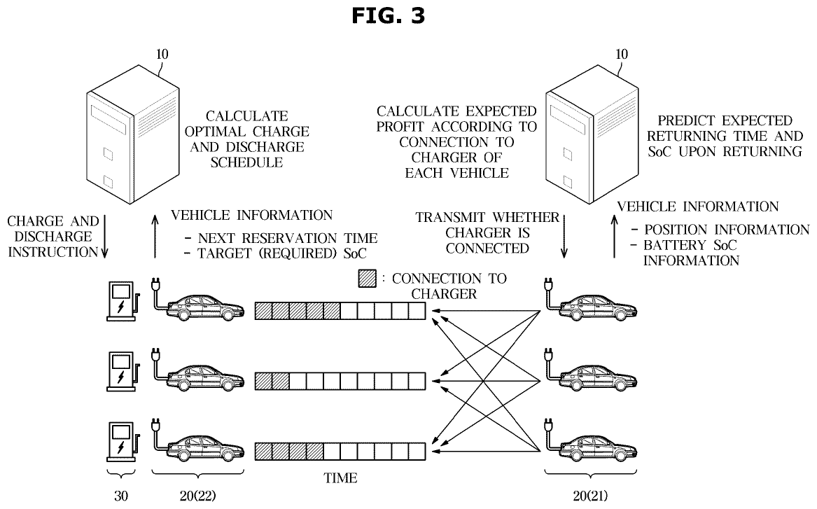

FIG. 3 schematically shows a case in which the server 10 according to an exemplary embodiment controls the V2G system 1.

Referring to FIG. 3, the server 10 according to various exemplary embodiments of the present disclosure may receive vehicle information such as position information, SoC information, and reservation information from each of the vehicles 20.

The server 10 may determine a plurality of first vehicles 21 returning to the position where the charger 30 is provided based on the position information of each of the vehicles 20 and determine the expected returning time and the expected SoC upon returning of each of the first vehicles 21 based on the position information and SOC information of each of the first vehicles 21.

Furthermore, the server 10 may determine at least one second vehicle 22 connected to the current charger 30 and being charged or discharged among the plurality of vehicles 20 based on the vehicle state information received from each of the vehicles 20 and determine a time point when the charger 30 is available based on the reservation information of each of one or more second vehicles 22. The server 10 may control the charger 30 to charge or discharge the second vehicle 22 connected to the charger 30 by determining an optimal charge and discharge schedule.

In other words, the server 10 may determine one or more first chargers to which the vehicle 20 is expected not to be connected at the expected returning times of the plurality of first vehicles 21 among the plurality of chargers 30 based on the next reservation time of each of one or more second vehicles 22 connected to the charger 30 and the expected returning time of each of the first vehicles 21 among the plurality of vehicles 20.

At the present time, the server 10 may determine the expected profit according to the connection to the charger 30 of each of the first vehicles 21 and determine the first vehicle 21 including the highest expected profit in each of one or more first chargers as the vehicle to be connected to each of one or more first chargers 30.

The server 10 may transmit whether to connect the charger 30 to each of the first vehicles 21. In other words, the server 10 may inform the connection to the charger 30 to a driver of the first vehicle 21 determined as the vehicle to be connected and inform the general parking to a driver of the first vehicle 21 which is not the vehicle to be connected.

It has been schematically described above that the server 10 determines the vehicle to be connected to the charger 30 among the plurality of returning vehicles to maximize the operating profit of the V2G system 1. Hereinafter, it will be described in more detail that the server 10 determines the returning vehicle and determines the vehicle to be connected to the charger 30 to maximize the operating profit of the V2G system 1 among the returning vehicles.

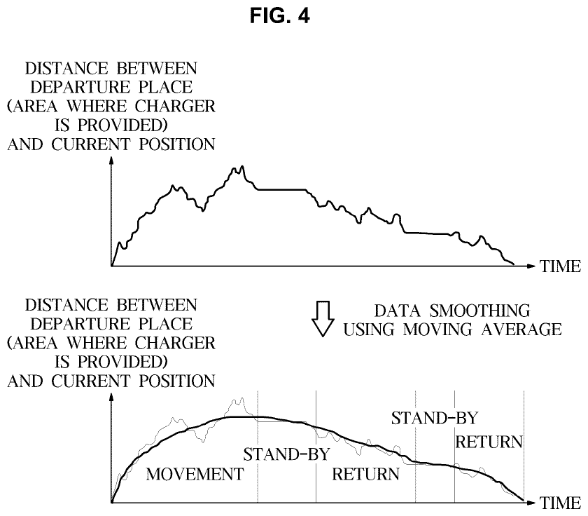

FIG. 4 is a view for describing a case in which the server 10 according to an exemplary embodiment identifies the vehicle 20 returning to the area where the charger 30 is provided.

Referring to FIG. 4, the server 10 according to various exemplary embodiments of the present disclosure may determine the plurality of first vehicles 21 returning to a departure place, that is, the area where the plurality of chargers 30 participating in the V2G system 1 are provided among the plurality of vehicles 20 based on the position information received from each of the vehicles 20 participating in the V2G system 1.

The server 10 may determine that the vehicle 20 in which a distance between the departure place (the area where the plurality of chargers 30 are provided) and the current position is decreased among the plurality of vehicles 20 is the first vehicle 21 based on the position information of each of the vehicles 20. In other words, the controller 120 may determine that the vehicle 20 approaching the area where the plurality of chargers 30 are provided is the first vehicle 21.

At the present time, according to the exemplary embodiment of the present disclosure, the server 10 may determine that the vehicle 20 in which the moving average over the time of the distance between the area where the plurality of chargers 30 are provided and the current position is decreased among the plurality of vehicles 20 is the first vehicle 21 based on the position information of each of the vehicles 20. In other words, the server 10 may determine smooth distance information by applying the moving average and determine whether to move, stand by, and return the vehicle 20 using the amount of distance changed to identify the trend for the increase or decrease in the distance considering that the distance between the departure place and the current position of the vehicle 20 repeatedly increases or decreases according to a traveling path on a road where the vehicle 20 travels.

Furthermore, the server 10 according to various exemplary embodiments of the present disclosure may determine the expected returning time to the area (e.g., the parking space) where the plurality of chargers 30 are provided of each of the first vehicles 21 using the position information of each of the first vehicles 21 and the known navigation algorithm. In other words, the server 10 may predict the expected returning time of the first vehicle 21 based on the remaining distance of the first vehicle 21.

Furthermore, the server 10 according to various exemplary embodiments of the present disclosure may predict the SoC at the expected returning time of each of the first vehicles 21 based on the SoC information received from each of the first vehicles 21 and the expected returning time of each of the first vehicles 21. For example, the server 10 may predict the SoC at the expected returning time by subtracting the amount of power to be consumed until the first vehicle 21 returns from the current SoC based on the current SoC, the current time, the expected returning time, and the average amount of power consumed per hour. In the instant case, the average amount of power consumed per hour may vary in accordance with the driver's driving habit, whether an air conditioner operates according to weather, and the like.

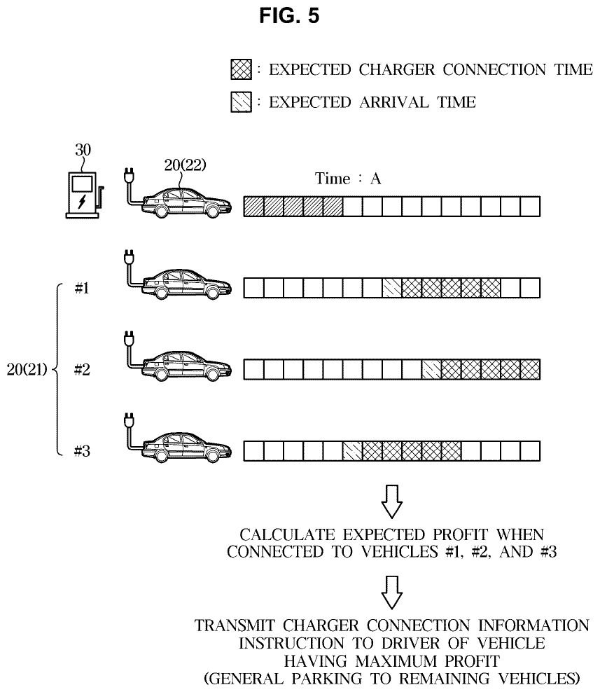

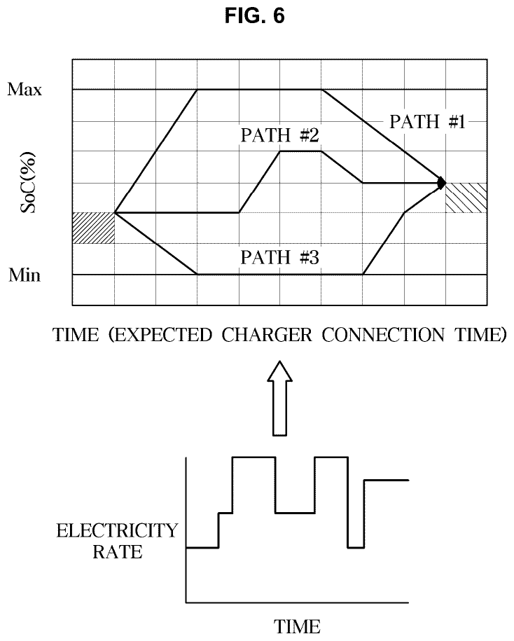

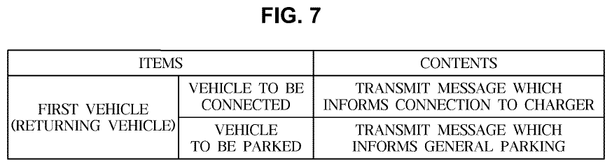

FIG. 5 is a view for describing a case in which the server 10 according to an exemplary embodiment determines the vehicle to be connected to the charger 30 among the returning vehicles 21, FIG. 6 is a view for describing that the server 10 according to an exemplary embodiment determines an expected profit, and FIG. 7 is a view for describing a case in which the server 10 according to an exemplary embodiment informs the connection to the charger 30 or the general parking to the driver.

Referring to FIG. 5, FIG. 6 and FIG. 7, the server 10 according to various exemplary embodiments of the present disclosure may determine the expected profit according to the charging and discharging of each of the first vehicles 21 at the available charger based on the electricity rate information over time and the expected returning time, the expected SoC at the expected returning time, the next reservation time, and the required SoC at the next reservation time of each of the first vehicles 21.

At the present time, the server 10 may store the electricity rate information over time received from the external server in the storage 130.

Furthermore, the server 10 may determine the next reservation time of each of the first vehicles 21 based on at least one of the reservation information received from the user terminal 40 and the reservation information input through the terminal of the service provider.

According to the exemplary embodiment of the present disclosure, the required SoC at the next reservation time may be a value preset by the service provider and stored in the server 10. However, according to the exemplary embodiment of the present disclosure, the server 10 may also determine the required SoC based on the reservation information. For example, the server 10 may adjust the required SoC to be increased as the reservation interval becomes longer. Furthermore, the server 10 may adjust the required SoC to be increased as the external temperature increases.

The server 10 according to various exemplary embodiments of the present disclosure may determine one or more first chargers 30 to which the vehicle 20 is expected not to be connected at the expected returning times of the plurality of first vehicles 21 among the plurality of chargers 30 based on the next reservation time of each of one or more second vehicles 22 connected to the charger 30 and the expected returning time of each of the first vehicles 21 among the plurality of vehicles 20.

At the present time, the server 10 may determine that the first vehicle 21 including the highest expected profit in each of one or more first chargers 30 is the vehicle to be connected to each of one or more first chargers 30.

For example, as shown in FIG. 5, the server 10 may predict that the charger 30 will be available at a next reservation time A of the second vehicle 22 and determine the first vehicles 21 (#1, #2, and #3) expected to return at the time when the charger 30 is expected to be available. The server 10 may determine the expected profit when each of the first vehicles 21 (#1, #2, and #3) is connected to the charger 30, transmit a charger 30 connection information instruction to the driver of the first vehicle 21 including the maximum profit, and inform the general parking to drivers of the remaining first vehicles 21.

The server 10 may determine the expected profit according to the charging and discharging of each of the first vehicles 21 at the available charger 30 based on the output of the optimization algorithm (e.g., the DP) for the electricity rate information over time, the expected returning time, the expected SoC at the expected returning time, the next reservation time, and the required SoC at the next reservation time of each of the first vehicles 21.

At the present time, the server 10 may determine a profit in the case including the highest sum of the income due to discharging and the expenditure due to charging as the SoC changes from the expected SoC to the required SoC from the expected returning time to the next reservation time (for an expected charger connection time) as the expected profit based on the electricity rate information over time.

For example, as shown in Expression 1, the server 10 may determine an optimized expected profit using an objective expression maximizing the sum of the amounts generated upon charging and discharging and constraint conditions including the expected returning time, the expected SoC at the expected returning time, the next reservation time, and the required SoC at the next reservation time.

max(Σᵢ₌₁^{N}Powerᵢ*Costᵢ) [Expression 1]

For example, as shown in FIG. 6, the server 10 may determine that a profit in a path including the highest sum of the income due to discharging and the expenditure due to charging among the plurality of paths (#1, #2, and #3) in which the SoC changes from the expected SoC to the required SoC from the expected returning time to the next reservation time (for the expected charger connection time) is the expected profit.

In other words, the server 10 may determine that a profit on a path in which the operating profit of the V2G system 1 may be increased by charging the battery of the vehicle 20 in a section where the electricity rate is low and discharging the battery of the vehicle 20 in a section where the electricity rate is high to decrease the cost required for charge and increase the cost obtained through discharge is the expected profit in the corresponding vehicle 20.

As described above, the server 10 can optimize the operating profit of the V2G system 1 by determining the plurality of first vehicles 21 returning to the area where the charger 30 is provided among the plurality of vehicles 20 participating in the V2G system 1 and determining the first vehicle 21 including the highest expected profit for each charger 30 as the vehicle to be connected to the charger 30 based on the electricity rate information over time and the vehicle information of each of the first vehicles 21.

As shown in FIG. 7, the server 10 according to various exemplary embodiments of the present disclosure may control the communicator 110 to transmit the message, which informs the connection to the charger 30, to at least one of the vehicles to be connected and the user terminal 40 of the driver of the vehicle to be connected.

As shown in FIG. 7, the server 10 according to various exemplary embodiments of the present disclosure may determine that the vehicle which is not the vehicle to be connected among the plurality of first vehicles 21 is the vehicle to be parked and control the communicator 110 to transmit the message, which informs the connection limit to the charger 30, to at least one of the vehicles to be parked and the user terminal of the driver of the vehicle to be parked.

Hereinafter, an exemplary embodiment of the method of controlling the server 10 according to one aspect will be described. The server 10 according to the above-described embodiment may be used in the method of controlling the server 10. Therefore, the contents described above with reference to FIGS. 1 to 7 may be applied to the method of controlling the server 10 in a same manner.

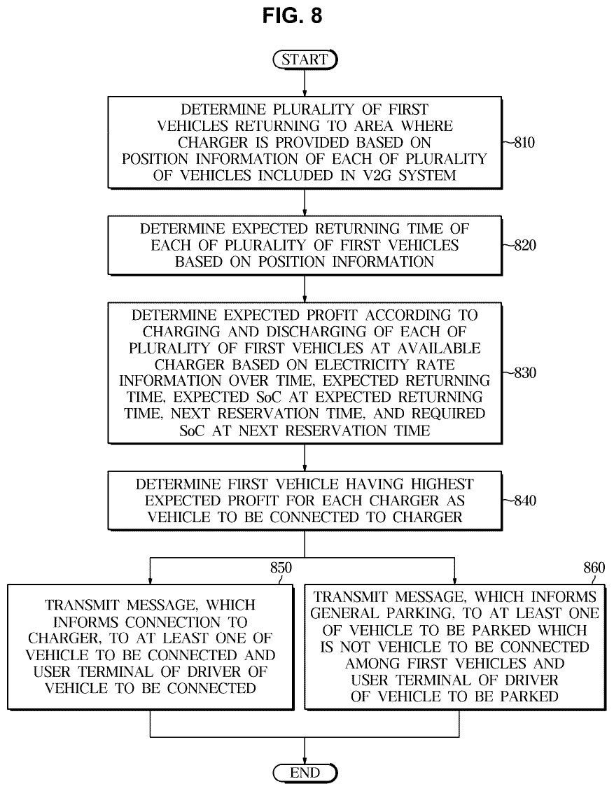

FIG. 8 is a flowchart of a case of determining the vehicle to be connected to the charger 30 among the returning vehicles 21 to maximize the operating profit of the V2G system in the method of controlling the server 10 according to an exemplary embodiment of the present disclosure.

Referring to FIG. 8, the server 10 according to various exemplary embodiments of the present disclosure may determine the plurality of first vehicles 21 returning to the area where the charger 30 is provided based on the position information of each of the vehicles 20 included in the V2G system 1 (810).

In other words, the server 10 may determine that the vehicle 20 in which the distance between the area where the plurality of chargers 30 are provided and the current position is decreased among the plurality of vehicles 20 is the first vehicle 21 based on the position information of each of the vehicles 20. In other words, the controller 120 may determine that the vehicle 20 approaching the area where the plurality of chargers 30 are provided is the first vehicle 21.

The server 10 according to various exemplary embodiments of the present disclosure may determine the expected returning time of each of the first vehicles 21 based on the position information (820).

In other words, the server 10 may determine the expected returning time to the area (e.g., the parking space), where the plurality of chargers 30 are provided, of each of the first vehicles 21 using the position information of each of the first vehicles 21 and the known navigation algorithm.

The server 10 according to various exemplary embodiments of the present disclosure may determine the expected profit according to the charging and discharging of each of the first vehicles 21 at the available charger 30 based on the electricity rate information over time, the expected returning time, the expected SoC at the expected returning time, the next reservation time, and the required SoC at the next reservation time (830).

The server 10 may determine the expected profit according to the charging and discharging of each of the first vehicles of the available charger 30 based on the output of the optimization algorithm (e.g., the DP) for the electricity rate information over time, the expected returning time, the expected SoC at the expected returning time, the next reservation time, and the required SoC at the next reservation time of each of the first vehicles.

At the present time, the server 10 may determine the profit in the case including the highest sum of the income due to discharging and the expenditure due to charging as the SoC changes from the expected SoC to the required SoC from the expected returning time to the next reservation time as the expected profit based on the electricity rate information over time.

The server 10 according to various exemplary embodiments of the present disclosure may determine that the first vehicle 21 including the highest expected profit for each charger 30 is the vehicle to be connected to the charger 30 (840).

The server 10 according to various exemplary embodiments of the present disclosure may transmit the message, which informs the connection to the charger 30, to at least one of the vehicles to be connected and the user terminal 40 of the driver of the vehicle to be connected (850).

The server 10 according to various exemplary embodiments of the present disclosure may transmit the message, which informs the general parking, to at least one of the vehicles to be parked which is not the vehicle to be connected among the first vehicles 21 and the user terminal 40 of the driver of the vehicle to be parked (860).

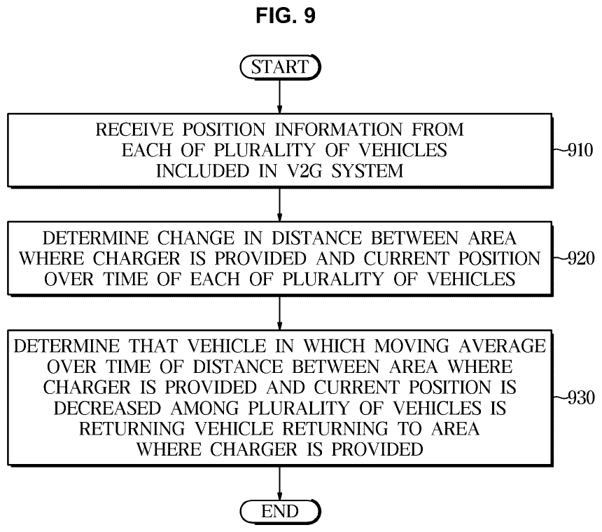

FIG. 9 is a flowchart of a case of determining the returning vehicle 21 among the plurality of vehicles 20 included in the V2G system 1 in the method of controlling the server 10 according to an exemplary embodiment of the present disclosure.

Referring to FIG. 9, the server 10 according to various exemplary embodiments of the present disclosure may receive the position information from each of the vehicles 20 included in the V2G system 1 (910) and determine the change in the distance between the area where the charger 30 is provided and the current position over time of each of the vehicles 20 (920).

The server 10 according to various exemplary embodiments of the present disclosure may determine that the vehicle in which the moving average over time of the distance between the area where the charger 30 is provided and the current position is decreased among the plurality of vehicles 20 is the returning vehicle returning to the area where the chargers are provided (930).

In other words, the server 10 may determine smooth distance information by applying the moving average and determine whether to move, stand by, and return the vehicle 20 using the amount of distance change to identify the trend in the increase or decrease in the distance considering that the distance between the departure place and the current position of the vehicle 20 repeatedly increases or decreases according to the traveling path on the road where the vehicle 20 travels.

Meanwhile, the disclosed exemplary embodiments of the present disclosure may be implemented in the form of a recording medium for storing instructions executable by a computer. The instructions may be stored in the form of program code, and may generate program modules to perform operations of the disclosed exemplary embodiments when executed by a processor. The recording medium may be implemented as a computer-readable recording medium.

Computer-readable recording media include all types of recording media in which instructions readable by the computer are stored. For example, there may be read only memories (ROMs), random access memories (RAMs), magnetic tapes, magnetic disks, flash memories, optical data storages, and the like.

In accordance with a server according to one aspect and a method of controlling the same, it is possible to improve charging and management efficiency of vehicles participating in a vehicle to grid (V2G) system by identifying returning vehicles returning to a position where chargers are provided among vehicles participating in the V2G system based on position information, determining a charge order among the returning vehicles, and informing the charge order.

In various exemplary embodiments of the present disclosure, the control device may be implemented in a form of hardware or software, or may be implemented in a combination of hardware and software.

Furthermore, the terms such as “unit”, “module”, etc. included in the specification mean units for processing at least one function or operation, which may be implemented by hardware, software, or a combination thereof.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the invention and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. A server comprising:
a communicator configured to communicate with a plurality of vehicles and a plurality of chargers; and
a controller configured to determine an expected returning time of each of first vehicles returning to an area where the plurality of chargers are provided among the plurality of vehicles and an expected profit according to charging and discharging of each of the first vehicles at an available charger among the plurality of chargers, and determine that a first vehicle including a highest expected profit for each charger among the plurality of first vehicles is a vehicle to be connected to each charger.

2. The server of claim 1, wherein the controller is configured to determine that a vehicle in which a distance between the area where the plurality of chargers are provided and a current position is decreased among the plurality of vehicles is the first vehicle based on position information of each of the vehicles received through the communicator.

3. The server of claim 2, wherein the controller is configured to determine that a vehicle in which a moving average over time of the distance between the area where the plurality of chargers are provided and the current position is decreased among the plurality of vehicles is the first vehicle based on the position information of each of the vehicles.

4. The server of claim 1, wherein the controller is configured to predict a state of charge (SoC) at the expected returning time of each of the first vehicles based on SoC information received from the plurality of first vehicles through the communicator and the expected returning time of each of the first vehicles.

5. The server of claim 1, wherein the controller is configured to determine the expected profit according to the charging and discharging of each of the first vehicles at the available charger based on an output of an optimization algorithm for electricity rate information over time, and the expected returning time, an expected SoC at the expected returning time, a next reservation time, and a required SoC at the next reservation time of each of the first vehicles.

6. The server of claim 5, wherein the controller is configured to determine that a profit in a case including a highest sum of an income due to discharging and an expenditure due to charging as an SoC changes from the expected SoC to the required SoC from the expected returning time to the next reservation time is the expected profit based on the electricity rate information over time.

7. The server of claim 1, wherein the controller is configured to determine one or more first chargers to which the vehicle is expected not to be connected at the expected returning times of the plurality of first vehicles among the plurality of chargers based on a next reservation time of each of one or more second vehicles connected to the charger among the plurality of vehicles and the expected returning time of each of the first vehicles.

8. The server of claim 7, wherein the controller is configured to determine that the first vehicle including the highest expected profit in each of the one or more first chargers is a vehicle to be connected to each of the one or more first chargers.

9. The server of claim 1, wherein the controller is configured to control the communicator to transmit a message, which informs a connection to the charger, to at least one of the vehicles to be connected and a user terminal of a driver of the vehicle to be connected.

10. The server of claim 1, wherein the controller is configured to determine that a vehicle which is not the vehicle to be connected among the plurality of first vehicles is a vehicle to be parked, and is configured to control the communicator to transmit a message, which informs a connection limit to the charger, to at least one of the vehicles to be parked and a user terminal of a driver of the vehicle to be parked.

11. A method of controlling a server including a communicator configured to communicate with a plurality of vehicles and a plurality of chargers, the method comprising:
determining, by the server, an expected returning time of each of first vehicles returning to an area where the plurality of chargers are provided among the plurality of vehicles and an expected profit according to charging and discharging of each of the first vehicles at an available charger among the plurality of chargers; and
determining, by the server, that a first vehicle including a highest expected profit for each charger among the plurality of first vehicles is a vehicle to be connected to each charger.

12. The method of claim 11, further including determining, by the server, that a vehicle in which a distance between the area where the plurality of chargers are provided and a current position is decreased among the plurality of vehicles is the first vehicle based on position information of each of the vehicles received through the communicator.

13. The method of claim 12, wherein the determining of the plurality of first vehicles includes determining that a vehicle in which a moving average over time of the distance between the area where the plurality of chargers are provided and the current position is decreased among the plurality of vehicles is the first vehicle based on the position information of each of the vehicles.

14. The method of claim 11, further including predicting, by the server, a state of charge (SoC) at the expected returning time of each of the first vehicles based on SoC information received from the plurality of first vehicles through the communicator and the expected returning time of each of the first vehicles.

15. The method of claim 11, wherein the determining of the expected profit includes determining the expected profit according to the charging and discharging of each of the first vehicles at the available charger based on an output of an optimization algorithm for electricity rate information over time, and the expected returning time, an expected SoC at the expected returning time, a next reservation time, and a required SoC at the next reservation time of each of the first vehicles.

16. The method of claim 15, wherein the determining of the expected profit includes determining a profit in a case including a highest sum of an income due to discharging and an expenditure due to charging as an SoC changes from the expected SoC to the required SoC from the expected returning time to the next reservation time as the expected profit based on the electricity rate information over time.

17. The method of claim 11, further including determining, by the server, one or more first chargers to which the vehicle is expected not to be connected at the expected returning times of the plurality of first vehicles among the plurality of chargers based on a next reservation time of each of one or more second vehicles connected to the charger among the plurality of vehicles and the expected returning time of each of the first vehicles.

18. The method of claim 17, wherein the determining of the vehicle to be connected includes determining that the first vehicle including the highest expected profit in each of the one or more first chargers is the vehicle to be connected to each of the one or more first chargers.

19. The method of claim 11, further including controlling, by the server, the communicator to transmit a message, which informs a connection to the charger, to at least one of the vehicles to be connected and a user terminal of a driver of the vehicle to be connected.

20. The method of claim 11, further including, by the server, determining that a vehicle which is not the vehicle to be connected among the plurality of first vehicles is a vehicle to be parked, and controlling the communicator to transmit a message, which informs a connection limit to the charger, to at least one of the vehicles to be parked and a user terminal of a driver of the vehicle to be parked.
